(19) United States
(12) Patent Application Publication
(10) Pub. No.: US 2005/0055650 A1
(43) Pub. Date: Mar. 10, 2005

(54) Automatic layout fill generation

(75) Inventors: Yiqun Lin, Melbourne, FL (US); Jeffrey M. Shoemaker, Indialantic, FL (US)

Correspondence Address: Fogg and Associates, LLC, P.O. Box 581339, Minneapolis, MN, 55458-1339, US

(73) Assignee: INTERSIL AMERICAS INC.

(21) Appl. No.: 10/655,829

(22) Filed: Sep. 5, 2003

(51) Int. Cl. G06F 9/45

(52) U.S. Cl. 716/5; 716/4; 716/11

(57) ABSTRACT

Methods of filling empty areas in a layout simulation. In one embodiment, a method of simulating an integrated circuit layout is disclosed. The method comprises automatically identifying empty areas in a layout that can be filled and generating fill patterns to fill the empty areas.

### TECHNICAL FIELD

The present invention relates generally to circuit simulations and in particular to filling empty areas in a layout simulation.

### BACKGROUND

Computer design simulation programs aid in the design of integrated circuits. In a typical process, a schematic diagram is first designed that defines a desired circuit. In particular, a schematic diagram defines the components of the circuit as well as the interconnect lines between the components. Simulation programs convert the schematic diagram to a physical layout (a layout) of the desired circuit in an integrated circuit. An integrated circuit includes various mask and metal layers. The metal layers in part are formed to provide the interconnection between the components of the circuit. Often, after a schematic diagram is converted to layout there occurs many so called “empty areas” in the various layers of the layout. An empty area is an area that can be filled by select fill patterns without causing a design rule checking (DRC) error. An empty area does not have to be absolutely empty without mask layers. That is, an empty area can contain shapes in areas that are irrelevant to fill patterns. These empty areas pose a problem because of design specifications. In particular, a design will have basic requirements regarding the percentages of metal and mask layers. For example, a design may require a metal 1 layer area to make up 20% to 50% of the available area and a metal 2 layer to make up 35% to 75% of the available area. In this example, if the metal 2 layer area is under 35% or over 75% the integrated circuit will not pass the DRC. A design that does not pass the DRC will not be accepted for manufacture. Accordingly, designers need to identify the empty areas and fill those empty areas with select layers to meet the percentage requirements.

A typical method of dealing with the empty areas is for the designers to visually identify the empty area. Once the empty areas are identified, the designer then has to determine what type of layer (i.e. metal 1, metal 2, mask) should be used to fill the empty area to reach the desired percentages as discussed above. Once the designer determines the type of layer to fill, the fill is manually placed in the empty areas of the layout using polygon shapes (polygons). Once the empty areas has been filled with the desired polygons, the design is tested for DRC errors and conductivity errors. If errors are detected, the integrated circuit layout has to be redesigned. This can be a time consuming process.

For the reasons stated above and for other reasons stated below which will become apparent to those skilled in the art upon reading and understanding the present specification, there is a need in the art for an improved method of filling empty areas in a layout.

### SUMMARY

The above-mentioned problems and other problems are resolved by the present invention and will be understood by reading and studying the following specification.

In one embodiment, a method of simulating an integrated circuit layout is disclosed. The method comprises automatically identifying empty areas in a layout that can be filled and generating fill patterns to fill the empty areas.

In another embodiment, another method of simulating an integrated circuit layout design is disclosed. The method comprises identifying empty areas in the layout design. Representing the empty areas and generating fill patterns to fill the empty areas.

In yet another embodiment, a machine readable medium having instructions stored thereon for simulating a layout of an integrated circuit is disclosed. The machine readable medium instructions comprises automatically identifying empty areas in a layout that can be filled and generating fill patterns to fill the empty areas.

### BRIEF DESCRIPTION OF THE DRAWINGS

The present invention can be more easily understood and further advantages and uses thereof more readily apparent, when considered in view of the description of the preferred embodiments and the following figures in which:

FIG. 1A is an example of an layout of an integrated circuit with empty areas of one embodiment of the present invention;

FIG. 1B is a layout of just the empty areas of FIG. 1A of one embodiment of the present invention;

FIG. 2 illustrates fill cells of one embodiment of the present invention;

FIG. 3 is an illustration of the contents of fill cells of FIG. 2;

FIG. 4 is a partial view of a section of a filled area of one embodiment of the present invention;

FIG. 5 is a partial view of a RX pattern simulation layer of one embodiment of the present invention;

FIG. 6 is a partial view of a MI pattern simulation layer of embodiment of the present invention;

FIG. 7 is a partial view of a AM pattern simulation layer of one embodiment of the present invention;

FIG. 8 is a partial view of a EN pattern simulation layer of one embodiment of the present invention;

FIG. 9 is an illustration of how an empty area is cut into smaller areas and filled with standard fill patterns; and

FIG. 10 is a flow chart illustrating one embodiment of implementing the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a tool that automatically identifies empty areas after a schematic to layout conversion. In one embodiment the empty areas are represented as polygons. The designers can then look at the empty areas and determine if they want to fill each of the empty areas automatically or not. Embodiments of the present invention fill the empty areas with fill patterns. Every fill pattern is a unique layout cell placed is a designated library. The fill cell consists of basic layout shapes (such as polygons) in any layer and parametralized cells (P-cells) or even another block of layer block. One embodiment of the present invention uses a configuration file to define fill patterns. Some embodiments of the present invention generate a hierarchical database which allows for the easy modification or move-ability of the field patterns in an empty area. In these embodiments, the designer can selectively fill select empty areas with select fill patterns. In addition, in one embodiment, the designer can simply indicate to fill all the empty areas which will then be filled with fill patterns selected by the tool. With both embodiments, the workload of the designer is reduced.

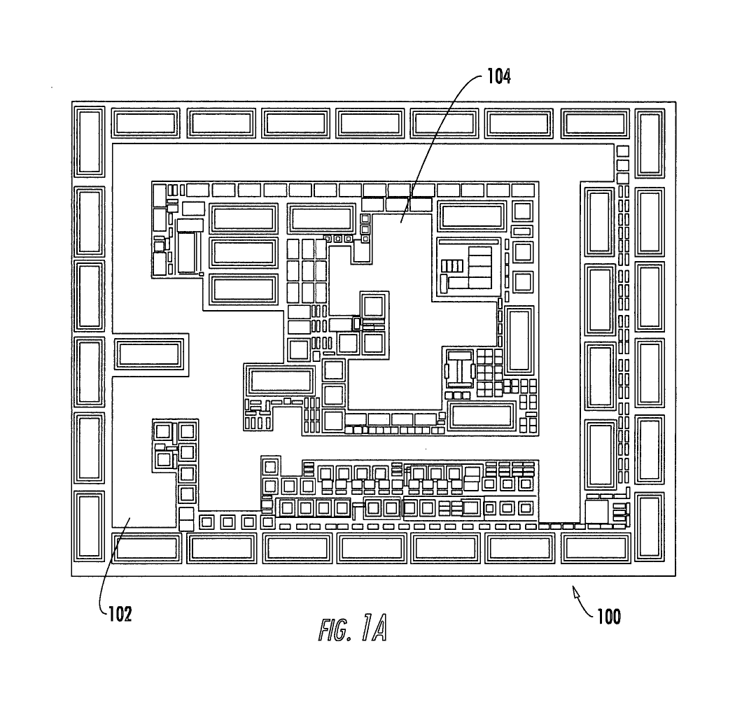

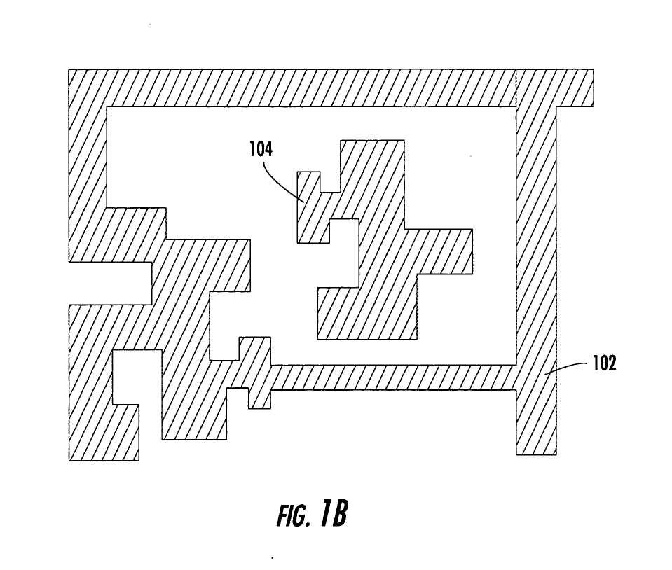

Referring to FIG. 1A, an example of an integrated circuit simulation 100 that has been converted during the simulation from a schematic diagram to a layout. The layout includes empty areas 102 and 104 between circuit devices. As illustrated the empty areas 102 and 104 are represented as empty polygons. Embodiments of the present invention, automatically find the empty areas in a layout with the use of a tool that runs a special empty area identification design rule program that is written based on the design rule checking DRC of the integrated circuit that is being simulated. By doing this, the empty areas can be found and filled with fill patterns and the layout after the fill can still remain DRC error free. FIG. 1B illustrates just the empty areas 102 and 104 of the integrated circuit. As illustrated in this example, the smaller empty area 104 is inside the larger empty area 102. These empty areas 102 and 104 represent select areas that need to be filled. Although, the empty areas are illustrated as being totally empty, this will not be the case in every situation. For example, one or more layers may be present but not represented in the simulation because these layers are irrelevant to the needed fill patterns.

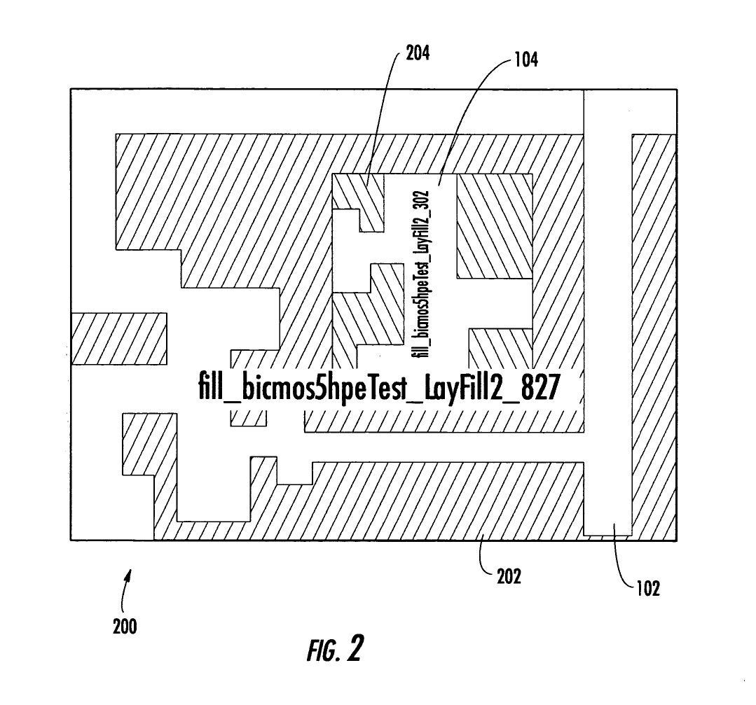

FIG. 2 represents a simulation with field areas (or cells) 200 in one embodiment of the present invention. In this example, empty area 102 is associated with fill cell 202 and empty area 104 is associated with fill cell 204. As illustrated the cells can be formed inside each other. Each cell 202 and 204 is given its own unique number. In this example, cell 202 is given the name fill_bicmos5hpeTest_layFill2_827 and the name of the cell 204 is fill_bicmos5hpeTest_layFill2_302. Each cell name is stored in a container library. The container library is a dedicated library to hold cells.

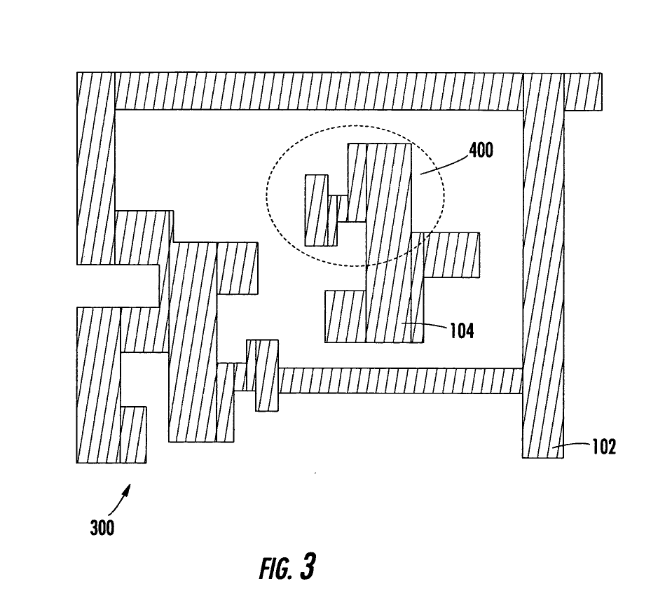

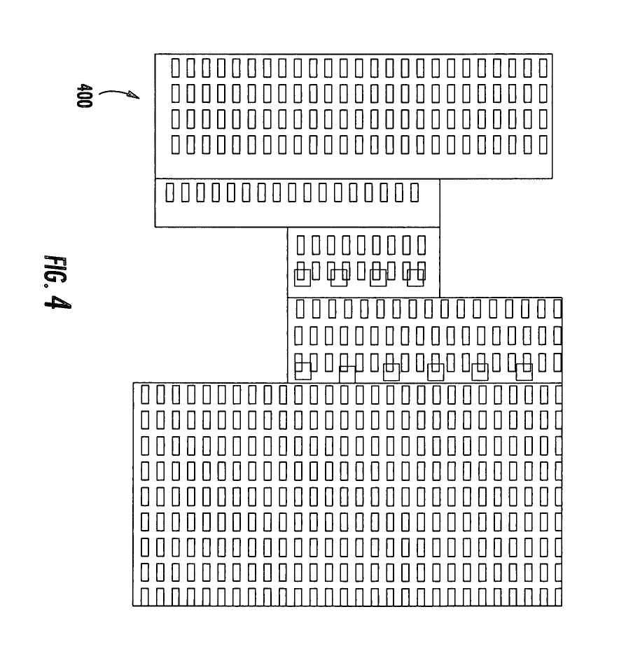

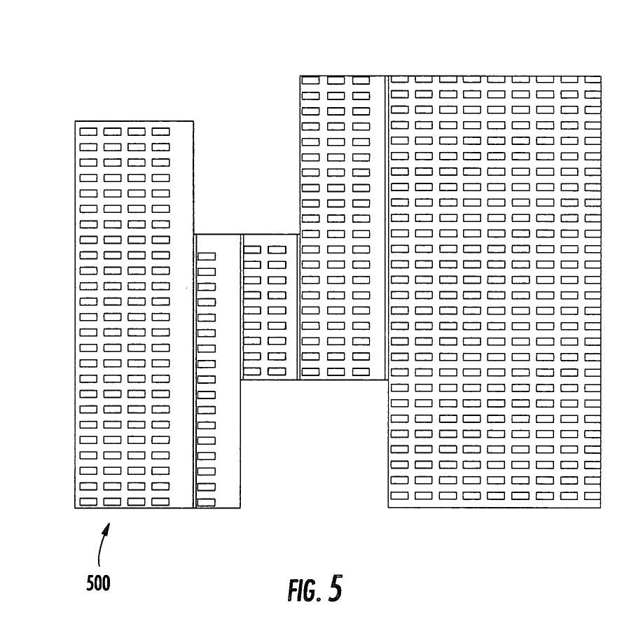

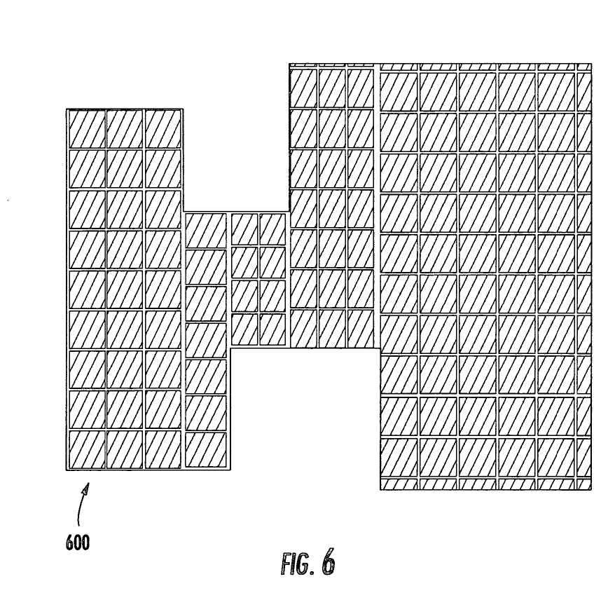

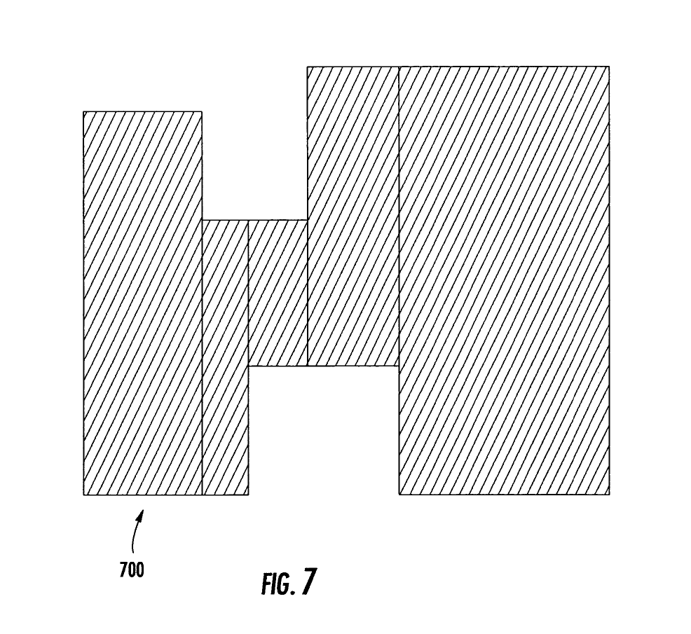

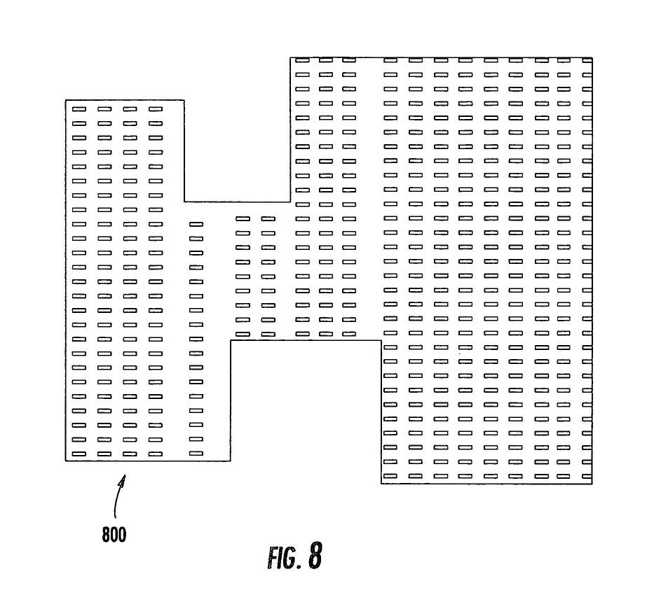

FIG. 3 is an illustration of a simulation 300 of the contents of fill cells of FIG. 2. In particular, FIG. 4 illustrates the different shapes that are generated by the tool to fill in the empty polygon areas 102 and 104. FIG. 4, is a close up view of a filled section 400 of area 104 (please refer back to FIG. 3). FIG. 4 illustrates in more detail the different shapes needed to complete a fill. As illustrated, it would take a considerable amount of time to manually draw all the small polygons to make the fill. As stated above, embodiments of the present invention reduce simulation time by automatically filling in the empty areas as desired. Referring to FIG. 5, a simulation of an RX pattern 500 layer is illustrated. RX pattern layer, illustrates one layer related to the empty area 104 after a fill simulation. RX is one of the mask layers. FIG. 6 is a simulation of a metal layer (MI pattern layer) 600. As illustrated, different layers have different design patterns because of design rule requirements. That is, different layers will have different design parameters as discussed above. For example, some layers cannot be drawn too large or too small. So different layers sometimes have to be drawn in different shapes. Other example simulation layers having different shapes are the AM pattern 700 of FIG. 7 and the EN pattern 800 of FIG. 8. EN of FIG. 8 is another mask layer. As illustrated in FIG. 8, small rectangles are used to fill in this mask layer 800.

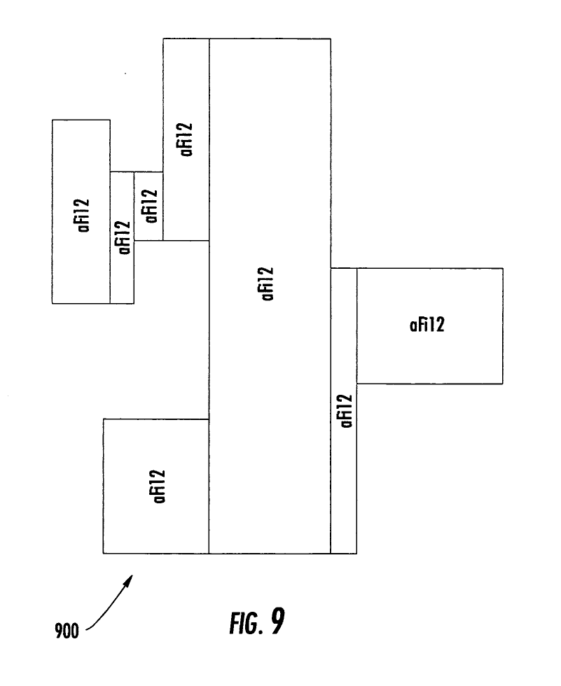

Embodiments of the present invention use an algorithm to fill in the empty spaces. Referring to FIG. 9 a simulation filled area 900 is shown. The simulation filled area is related to empty area 104 of FIG. 1. The algorithm is a recursive partition algorithm. The algorithm separates (or cuts) the polygons into multiple rectangles as illustrated in FIG. 9. In particular, each rectangle is labeled as aFil2 in FIG. 9. Once the polygon has been cut into the rectangles each rectangle is filled with select shapes by the tool of the present invention.

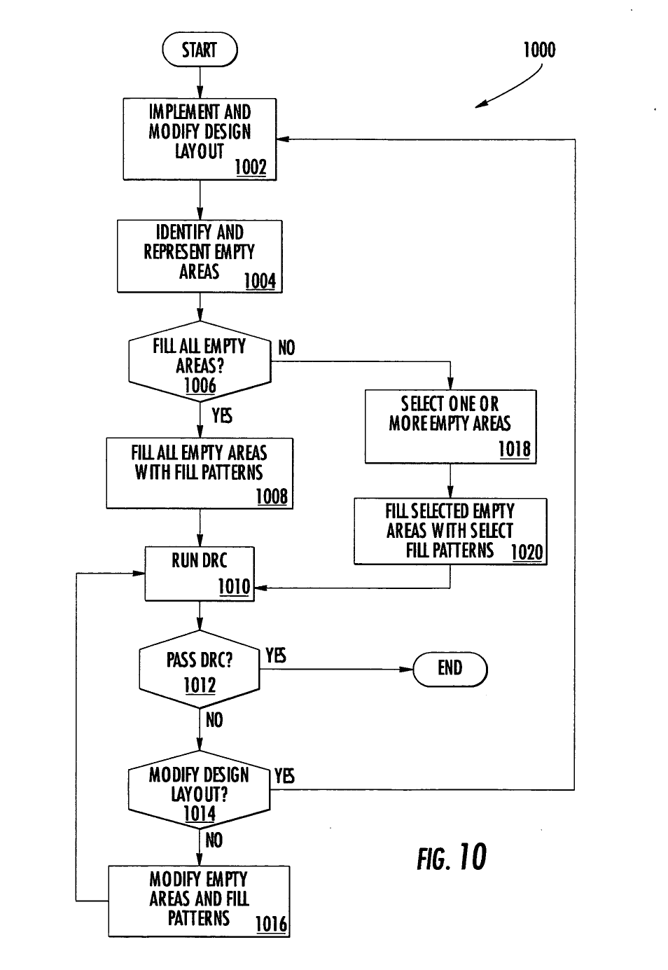

Referring to FIG. 10, a flow chart 1000 illustrating one embodiment of implementing the present invention is shown. The process starts by implementing and modifying the design layout (1002). The empty areas are then identified and represented as select areas that may need to be filed (1004). In one embodiment, the select areas are represented as polygons. The designer then determines if all the empty areas should be filled automatically with fill patterns (1006). If the designer decides not to fill all the empty areas automatically (1006), one or more empty areas are selected by the designer to be filled (1018). The selected empty areas are then filled with select fill patterns (1020). If the designer decides to fill all the empty areas automatically (1006), all the empty areas are filled with fill patterns (1008). Once the empty areas are filled, a design rule checking (DRC) test is run (1010). It is then determined if the design passes the DRC (1012). If the design passes the DRC (1012) the process ends. If the design does not pass the DRC (1012), the designer must determine if they want to modify the design layout (1014). If the designer does not want to modify the design layout (1014), the empty areas and fill patterns are modified (1016). The flow chart 1000 then continues by running the DRC at 1010. If the designer wants to modify the design layout (1014), the flow chart 1000 continues at 1002.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of simulating an integrated circuit layout, the method comprising:
automatically identifying empty areas in a layout that can be filled; and
generating fill patterns to fill the empty areas.

2. The method of claim 1, further comprising:
automatically filling the empty spaces with the fill patterns.

3. The method of claim 1, further comprising:
selecting the fill patterns; and
placing the fill patterns in empty areas to fill the empty areas.

4. The method of claim 1, further comprising:
filling select empty areas with the fill patterns.

5. The method of claim 1, further comprising:
defining a unique layout cell for each fill pattern that is placed in a designated library.

6. The method of claim 1, further comprising:
using a configuration file to define the fill patterns.

7. The method of claim 1, wherein automatically identifying empty areas in a layout that can be filled, further comprises:
running an empty area identification design tool that is based on design rule checking (DRC) requirements.

8. The method of claim 1, further comprising:
using a hierarchical database that is adapted to provide easy modification or move-ability of fill patterns.

9. The method of claim 1, further comprising:
filling select empty areas with the fill patterns, wherein the select empty areas represent different layers of mask and metal in the integrated circuit.

10. The method of claim 9, wherein at least one of the different layers is filled with different shape fill patterns than the shapes in fill patterns of the other different layers.

11. A method of simulating an integrated circuit layout design, the method comprising:
identifying empty areas in the layout design;
representing the empty areas; and
generating fill patterns to fill the empty areas.

12. The method of claim 11, wherein the empty areas are represented as polygons.

13. The method of claim 12, further comprising:
using a recursive partition algorithm on select empty areas to partition the select empty areas into multiple rectangles to be filled with the fill patterns.

14. The method of claim 1 1, further comprising;
filling empty areas with the fill patterns.

15. The method of claim 14, further comprising:
running a design rule checking (DRC) test on the design.

16. The method of claim 15, further comprising:
when the design does not pass the DRC test, modifying the design layout.

17. The method of claim 15, further comprising:
when the design does not pass the DRC test, modifying the empty areas and fill patterns.

18. The method of claim 11, further comprising;
selecting one or more fill patterns; and
filling selected empty areas with select fill patterns.

19. The method of claim 18, further comprising:
running a design rule checking (DRC) test on the design.

20. The method of claim 19, further comprising:
when the design does not pass the DRC test, modifying the design layout.

21. The method of claim 19, further comprising:
when the design does not pass the DRC test, modifying the empty areas and fill patterns.

22. A machine readable medium having instructions stored thereon for simulating a layout of an integrated circuit, the machine readable medium instructions comprising:
automatically identifying empty areas in a layout that can be filled; and
generating fill patterns to fill the empty areas.

23. The machine readable medium instructions of claim 22, further comprising:
automatically filling the empty spaces with the fill patterns.

24. The machine readable medium instructions of claim 22, further comprising:
selecting the fill patterns; and
placing at least one select fill pattern in at least one empty area to fill the at least one empty area.

25. The machine readable medium instructions of claim 22, further comprising:
defining a unique layout cell for each fill pattern that is placed in a designated library.

26. The machine readable medium instructions of claim 22, further comprising:
using a configuration file to define the fill patterns.

27. The machine readable medium instructions of claim 22, wherein automatically identifying empty areas in a layout that can be filled, further comprises:
running an empty area identification design tool that is based on design rule checking (DRC) requirements.

28. The machine readable medium instructions of claim 22, further comprising:
using a hierarchical database that is adapted to provide easy modification or move-ability of fill patterns.

29. The method of claim 22, wherein the empty areas are represented as polygons.

30. The method of claim 29, further comprising:
using a recursive partition algorithm on select empty areas to partition the select empty areas into multiple rectangles to be filled with the fill patterns.

31. The method of claim 22, further comprising:
filling select empty areas with the fill patterns, wherein the select empty areas represent different layers of mask and metal in the integrated circuit.

32. The method of claim 31, wherein at least one of the different layers is filled with different shape fill patterns than the shapes in fill patterns of the other different layers.
